(19) United States
(12) Patent Application Publication
(10) Pub. No.: US 2008/0138598 A1
(43) Pub. Date: Jun. 12, 2008

(54) Apparatus and Method for Co-Extrusion of Articles Having Discontinuous Phase Inclusions

(75) Inventors: Matthew J. Michel, St. Paul, MN (US); Jay M. Jennen, Forest Lake, MN (US); Laurence E. Schwanz, Inver Grove Heights, MN (US); David L. Vall, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/608,476

(22) Filed: Dec. 8, 2006

(51) Int. Cl. B29C 47/12; B29C 47/10; B29C 47/06; B32B 3/00

(52) U.S. Cl. 428/221; 425/131.1; 264/173.12; 264/172.13; 264/173.15

(57) ABSTRACT

The present disclosure provides an apparatus and methods for producing co-extruded composite webs including a continuous layer of an extruded matrix material, and a multiplicity of included phases embedded in the continuous layer. The included phases are surrounded by the matrix material to form a single-layer composite web within a feed block having an internal die body. The included phases are separate from each other by being discontinuous in the cross-web direction, but the included phases may be substantially continuous in the down-web direction. In some exemplary embodiments, the co-extruded single-layer composite web may be used in a single-layer or multi-layer article. In other exemplary embodiments, the single-layer co-extruded composite web may be in the form of a sheet, a film, a blown film, a filament, a fiber, a tube, and the like.

### TECHNICAL FIELD

This disclosure relates to a co-extrusion apparatus including a die feed block, a method of using the feed block to produce co-extruded articles having discontinuous phase inclusions, and co-extruded articles produced therewith.

### BACKGROUND

Extruded polymers are used in many applications, including the production of filaments and fibers for use in fabrics; or thin films for use as tape backings, packaging materials, and the like. Exemplary polymeric materials suitable for extrusion include crystalline polyolefins, such as polyethylene, polypropylene, and polybutylene; polyamides such as nylon; polyesters such as polyethylene terephthalate (PET); and polyvinylidene fluoride. Although these polymeric materials and others are suitable for use in forming a polymeric fiber or web, they can have limiting characteristics that substantially narrow their suitable uses. For example, extruded polypropylene webs often have very good flexibility and tensile strength, but have less than desirable cross-web tear strength. On the other hand, PET exhibits good tear resistance, but a PET web may become brittle and may be not readily heat-sealable.

In order to improve the properties of extruded polymeric articles, several different polymeric materials are often co-extruded to form a multi-layer film or fiber. In general, each co-extruded layer forms a separate continuous phase within the article. An exemplary hybrid polymeric web combining two polymers is described in Krueger et al. (U.S. Pat. No. 5,429,856). Japanese Patent Document No. 55/28825 illustrates a multi-manifold die capable of producing a continuous core layer sandwiched within an upper layer and a lower layer. As exemplified by U.S. Pat. No. 3,397,428 to Donald, U.S. Pat. No. 3,479,425 to Lefevre et al, U.S. Pat. No. 3,860,372 to Newman, Jr., and U.S. Pat. No. 4,789,513 to Cloeren, encapsulation of a core stream in a surrounding multi-layer polymeric matrix is also known. U.S. Pat. No. 3,458,912 to Schrenk et al., U.S. Pat. No. 5,429,856 to Krueger et al., and U.S. Pat. No. 5,800,903 to Wood et al. describe various co-extrusion dies and co-extrusion methods for preparing composite articles having a discontinuous core layer sandwiched between two distinct skin layers formed of a polymeric matrix material.

Various methods have been described for producing co-extruded polymeric films incorporating a continuous polymeric phase as a core layer sandwiched between adjacent continuous polymeric phase layers. The art continually searches for new co-extrusion apparatuses and improved methods for preparing composite articles having unique phase configurations.

### SUMMARY

In general, the present disclosure relates to an improved co-extrusion apparatus and methods of preparing co-extruded articles. The improved apparatus includes a feed block having an internal die having a plurality of orifices used to form discontinuous phase inclusions in a continuous matrix material. The internal die allows formation of discontinuous phase inclusions of a first extrudable material embedded in a surrounding matrix of a second extrudable material, thereby forming a single-layer composite web. The feed block may be used in combination with an external die to form a single or multi-layer composite article in the form of a web, sheet, film, blown film, filament, fiber, tube, and the like.

In one aspect, the present disclosure provides a co-extrusion apparatus including a feed block having a first flow channel and a second flow channel, each of which has a transverse land channel in fluid communication with a first fluid delivery conduit. A die body is disposed between the first flow channel and the second flow channel within the feed block. The die body includes a transverse flow-providing passage in fluid communication with a transverse die exit channel. The transverse die exit channel includes a plurality of orifices formed on an external face of the internal die body in fluid communication with a second fluid delivery conduit. The feed block has a first internal wall which cooperates with a first face of the die body to form the transverse land channel of the first flow channel, and a second internal wall which cooperates with a second face of the die body to form a transverse land channel of the second flow channel. A feed block exit channel is formed in an external face of the feed block in fluid communication with the first flow channel, the second flow channel, and the transverse die exit channel.

In another aspect, the present disclosure provides a method of making a composite article having a discontinuous phase inclusion embedded in a continuous matrix material. The method includes introducing a first extrudable material into a first flow channel and a second flow channel formed within a feed block, introducing a second extrudable material into a plurality of orifices formed in a transverse exit channel on an external face of an internal die body disposed between the first flow channel and the second flow channel within the feed block, and combining the first extrudable material and the second extrudable material in a feed block exit channel to form a single-layer composite web. The first extrudable material forms a continuous matrix material surrounding a plurality of discontinuous included phases embedded in the continuous matrix material. The discontinuous included phases are separate from each other by being discontinuous in a cross-web direction, but are substantially continuous in the down-web direction.

In still another aspect, the present disclosure provides a method of making a composite article having certain properties, for example a physical property gradient between the discontinuous phase and the surrounding matrix material.

In yet another aspect, the present disclosure provides a co-extruded composite article including a continuous layer of an extruded matrix material, and a multiplicity of included phases embedded in the continuous layer. The included phases are surrounded by the matrix material to form a single-layer. The included phases are separate from each other by being discontinuous in the cross-web direction, and the included phases are substantially continuous in the down-web direction. In some exemplary embodiments, the co-extruded composite article is in the form of a single-layer web, sheet, film, blown film, filament, fiber, and the like. In other exemplary embodiments, the co-extruded composite article is in the form of a multi-layer web, sheet, film, blown film, filament, fiber, and the like.

Incorporation of the discontinuous phase inclusions in the matrix material within the feed block may provide several advantages. Discontinuous phase inclusions with dimensions smaller in the web thickness direction than in the web width direction may be produced. Multiple layers may be extruded around the composite layer containing the discontinuous phase inclusions to form multi-layer composite films having an embedded composite layer having discontinuous phase inclusions within a matrix material.

The above summary is not intended to describe each illustrated embodiment or every implementation of the present disclosure. The Figures and the Detailed Description that follow more particularly exemplify certain preferred embodiments using the principles disclosed herein.

### BRIEF DESCRIPTION OF THE DRAWINGS

Unless otherwise noted herein, the Drawings are for illustrative purposes only and are not drawn to scale.

FIG. 1A is a schematic end view of an exemplary apparatus for production of a co-extruded composite web having discontinuous phase inclusions in a matrix material in accordance with an embodiment of Applicant's disclosure.

FIG. 1B is a cross-sectional, cross-web edge view of an exemplary single-layer composite web having discontinuous phase inclusions in a matrix material formed in accordance with an embodiment of Applicant's disclosure.

FIG. 2A is a cutaway end view of an exemplary feed block including an internal die body and an external die for forming a single-layer co-extruded composite web having discontinuous phase inclusions in a matrix material in accordance with an embodiment of Applicant's disclosure.

FIG. 2B is a cutaway perspective view of the tip section of the internal die body and feed block of FIG. 2A, showing the plurality of orifices formed in the external face of the internal die.

FIG. 3 is a cutaway end view of another exemplary feed block including an internal die and a pair of downstream forming channels with adjustable vanes for forming a multi-layer co-extruded composite article having discontinuous phase inclusions in a matrix material in accordance with another embodiment of Applicant's disclosure.

FIG. 4A is a cross-sectional end view of the tip section of the internal die body and feed block of FIG. 3.

FIG. 4B is a perspective view of the internal die body of FIG. 3, showing the plurality of orifices formed in the external face of the internal die.

FIGS. 5A-5J are cross-sectional edge views of various single-layer and multi-layer polymeric films having discontinuous phase inclusions in a matrix material made in accordance with exemplary embodiments of Applicant's disclosure.

### DETAILED DESCRIPTION

With respect to the above discussion of composite co-extruded articles, Applicants have discovered that novel composite articles may be prepared using co-extrusion methods that make use of an improved co-extrusion apparatus. The improved apparatus includes a feed block having an internal die having a plurality of orifices. The plurality of orifices permits formation of discontinuous phase inclusions of a first extrudable material embedded in a surrounding matrix of a second extrudable material, thereby forming a single-layer composite web. By discontinuous, we mean that the phase inclusions are not continuous in extent in at least one direction (e.g. the cross-web direction). However, it will be understood that the discontinuous phase may be continuous in another direction within the web (e.g. the down-web direction) and may be formed in a time-wise continuous manner.

The single-layer composite web may be overlayed on one or both sides with one or more additional layers of additional extrudable material(s). The additional extrudable material(s) may be applied within the feed block and/or the die. The resulting single-layer or multi-layer composite articles (for example, a sheet, filament, fiber, tube, article, and the like.) may have a uniform surface without the surface waviness or “rippling” that accompanies formation of multi-layer composite articles by overlaying extrudable material on a discontinuous core material within an external die. The resulting composite articles may also have unique configurations in which the composite layer having the discontinuous phase inclusions embedded in a matrix material may be an outer layer (i.e. a top layer or a bottom layer) in a multi-layer stack. Such composite structures are unique to Applicant's disclosed method and apparatus for co-extrusion of articles having discontinuous phase inclusions.

The embodiments described herein may take on various modifications and alterations without departing from the spirit and scope of the disclosure. Accordingly, it is understood that the disclosure is not to be limited o the following described embodiments, but is to be controlled by the limitations set forth in the claims and any equivalents thereof. In particular, all numerical values and ranges recited herein are intended to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5). Various embodiments of the disclosure will now be described with reference to the Figures.

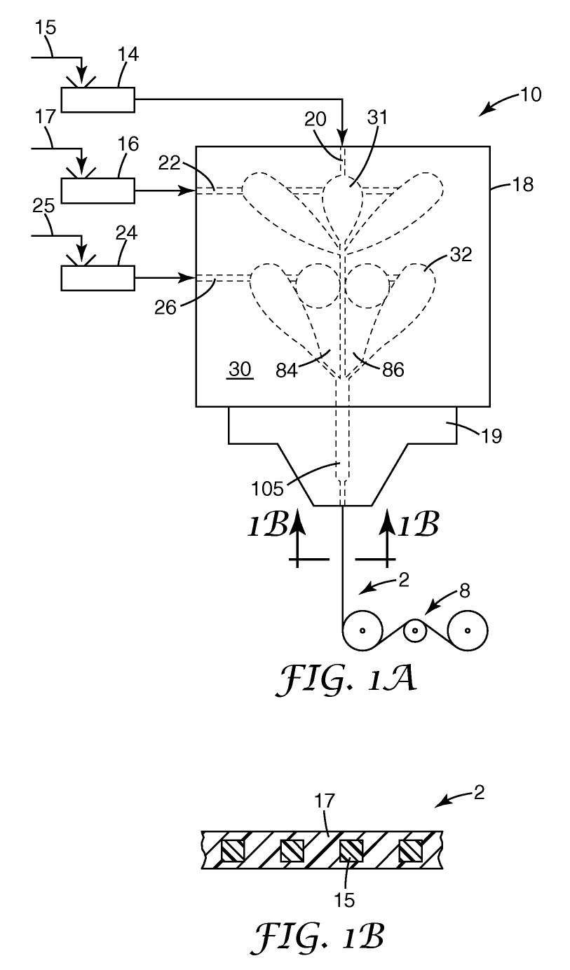

Referring to FIG. 1A, a schematic view of an extrusion apparatus 10 for manufacturing a co-extruded article including a single-layer composite web 2 (see FIG. 1B) in accordance with an embodiment of the invention is shown. In the embodiment depicted, system 10 includes extruders 14 and 16, as well as an external die 19 and a die feed block 18. The extruders 14 and 16 respectively contain first and second extrudable materials 15 and 17, and provide streams of first and second extrudable materials 15 and 17 through first fluid delivery conduit 20 and second fluid delivery conduit 22, respectively, to feed block 18.

The feed block 18 includes an internal cavity 30 containing an internal die 31 having a plurality of orifices (not shown in FIG. 1A) used to form discontinuous phase inclusions of first extrudable material 15 in a continuous matrix of second extrudable material 17, thereby forming a single-layer composite web 2, as shown in FIG. 1B. The feed block 18 may be used in conjunction with a forming channel 105 within external die 19 to form a single or multi-layer article incorporating the single-layer composite web 2 in the form of a sheet, filament, fiber, tube, and the like. In certain embodiments, a web handling system 8, for example, a plurality of rollers, may be used to collect (e.g. wind up) the co-extruded article including a single-layer composite web 2.

As illustrated by FIG. 1B and detailed below, the extrudable materials 15 and 17 may be extruded from the feed block 18 such that second extrudable material 17 substantially surrounds or forms a matrix around first extrudable material 15, which becomes the discontinuous phases embedded within the matrix, thereby forming a single-layer composite web 2 having discontinuous phase inclusions.

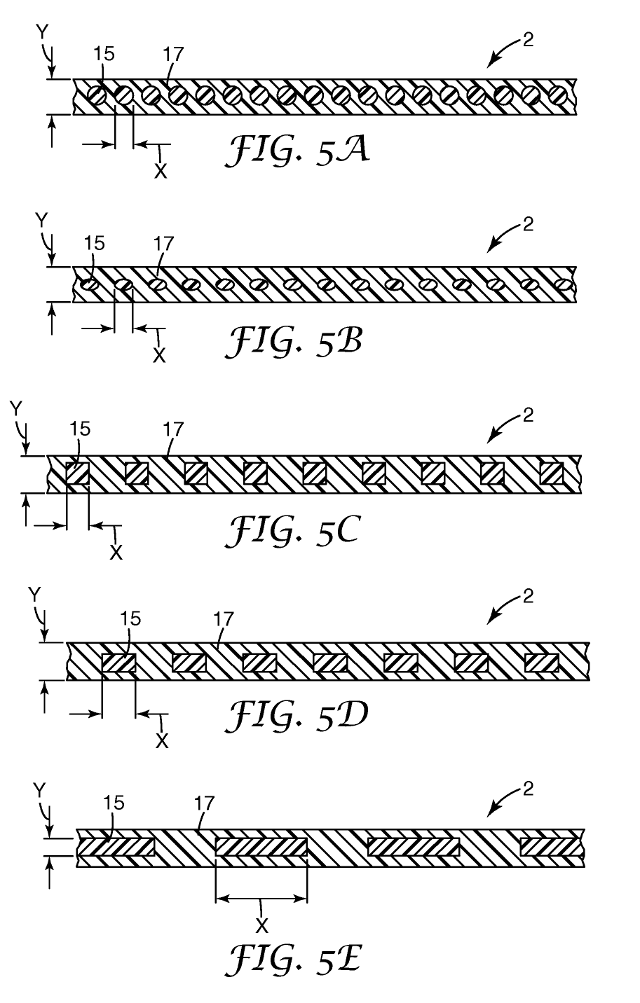

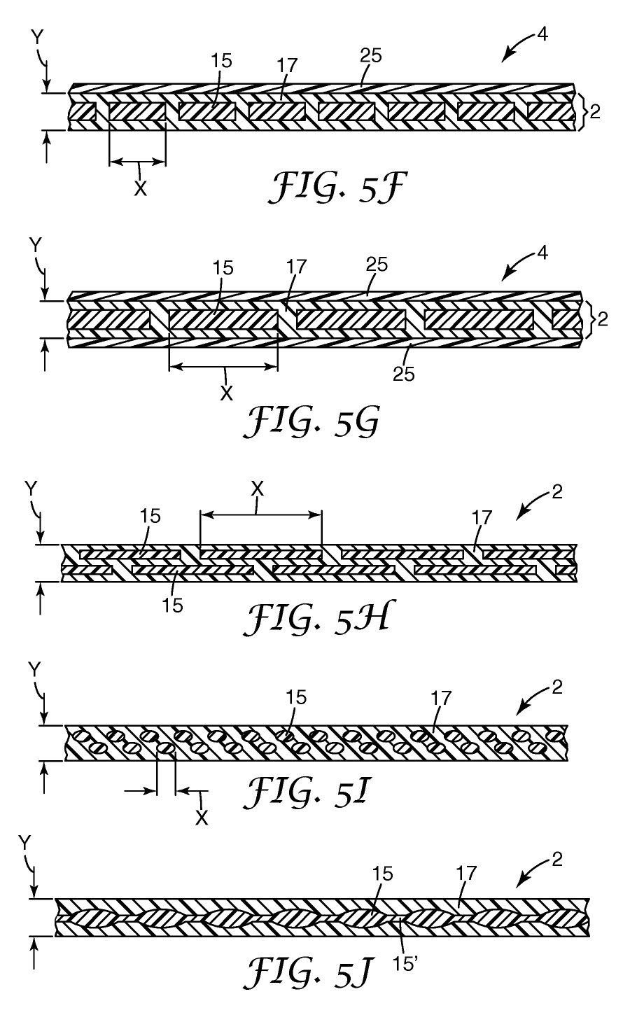

In certain optional embodiments, one or more additional extruders, for example a third extruder 24 as shown in FIG. 1A, may be used to feed one or more stream of an additional extrudable material 25 into the feed block 18 to form one or more layers of the additional extrudable material 25 adjacent to the matrix material on one or both sides of the composite web (see, e.g., FIGS. 5F and 5G). The additional extrudable material 25 may be the same as or different from the first 15 or second 17 extrudable materials. If additional extrudable material 25 is applied to both sides of the web of composite material exiting the feed block, the composition of the additional extrudable material 25 need not be identical on both sides of the single-layer composite web. If the additional extrudable material 25 is not identical on both sides of the single-layer composite web, then it is preferred that each additional extrudable material be fed from a separate extruder through a separate feed manifold to the feed block.

In one such optional embodiment illustrated in FIG. 1, at least one pair 32 of layer-forming channels is positioned within the feed block downstream of internal die 31. Each pair 32 of layer-forming channels is in fluid communication with the third fluid delivery conduit 26. Each of the layer-forming channels is positioned proximate an adjustable vane 84 or 86, and each adjustable vane 84 or 86 is movably positioned to at least partially occlude a corresponding layer-forming channel. In some embodiments, at least one adjustable adjustable vane 84 and 56 is positioned to fully occlude the corresponding layer-forming channel.

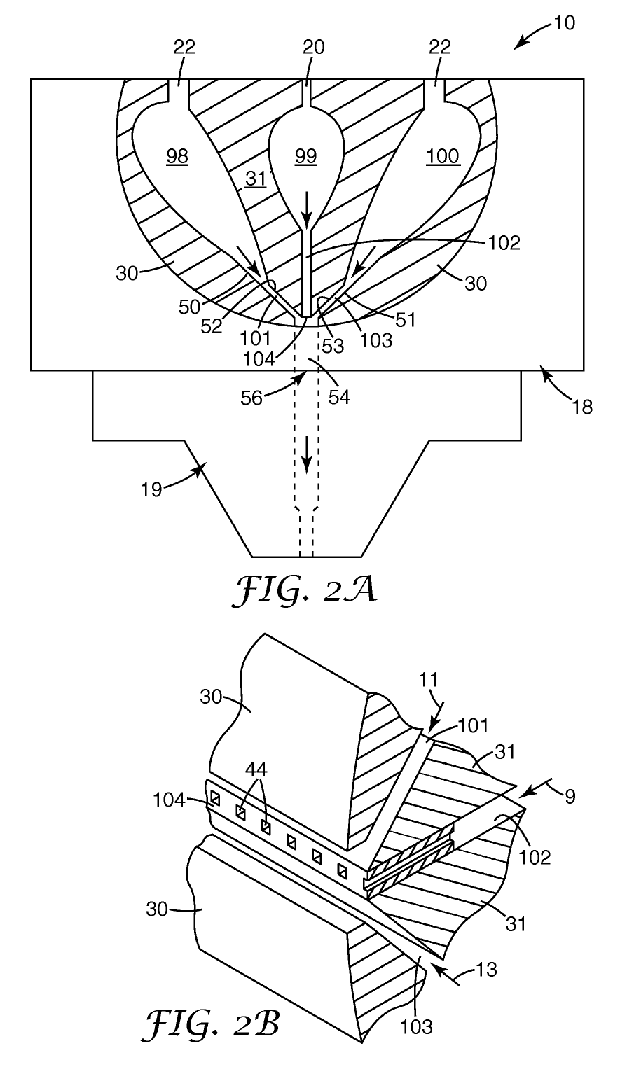

FIGS. 2A and 2B illustrate more particularly an exemplary extrusion apparatus 10 useful in producing an extruded single-layer composite web. The exemplary extrusion apparatus 10 includes a feed block 18 with an internal die body 31 without any optional pair of layer forming channels, attached to an external die 19 as shown in FIGS. 2A and 2B. The internal die body 31 is positioned within a cavity 30 formed within the feed block 18.

Referring to FIG. 2A, the feed block 18 has a first internal wall 50 which cooperates with a first face 52 of the die body 31 to form a first flow channel 101, and a second internal wall 51 which cooperates with a second face 53 of the die body 31 to form a second flow channel 103. A feed block exit channel 54 is formed in an external face 56 of the feed block 18 in fluid communication with the first flow channel 101, the second flow channel 103, and the transverse internal die exit channel 102. The first flow channel 101 is in fluid communication with a transverse land channel 98, and the second flow channel 103 is in fluid communication with another transverse land channel 100. Each transverse land channel 98 and 100 is in fluid communication with a fluid delivery conduit, for example, the second fluid delivery conduit 22.

Referring to FIG. 2B, the internal die body 31 is disposed between the first flow channel 101 and the second flow channel 103 within the feed block 18. The die body 31 includes a transverse flow-providing passage (not shown) in fluid communication with a transverse internal die exit channel 102. The transverse internal die exit channel 102 exits the external face 104 of the internal die body 31 through a plurality of orifices 44 in fluid communication with the first fluid delivery conduit 20 (not shown in FIG. 2B; see FIG. 2A). FIG. 2B illustrates that fluid streams 11 and 13, which in some embodiments are made up of second extrudable material 17, combine to encapsulate or embed fluid stream 9 of first extrudable material 15, which exits the plurality of orifices 44 in a cross-web discontinuous phase.

Although in some embodiments streams 11 and 13 are made up of the same material (e.g. second extrudable material 17), streams 11 and 13 may include different materials, provided that each transverse land channel 98 and 100 is in fluid communication with a separate fluid delivery conduit, each supplying a different extrudable material from a separate extruder (not shown in the Figures).

The apparatus 10 shown in FIGS. 2A-2B may, in some embodiments, be able to reproduce in the embedded discontinuous included phases the relative dimensions of the orifices 44 to a degree that has not previously been known. In one aspect where the orifices 44 have substantially the same dimensions, the width of the discontinuous embedded phases are remarkably uniform. The shape and position of orifices 44 define the shape and position of the plurality of distinct embedded phases in the polymeric web. Each of the plurality of orifices 44 may have virtually any shape. In particular, circular orifices, elliptical orifices, square orifices, rectangular orifices, triangular orifices, and polygonal orifices having more than four sides may be used advantageously in certain embodiments. In some embodiments, the orifices 44 may be arranged in a two-dimensional array across the surface of the transverse die exit channel.

The orifices 44 can be made, for example, by electro-discharge machining (EDM) or other material removal means known in the art. Preferably, each orifice 44 is at least 1 mm from the nearest adjacent orifice in order to prevent merger of the discontinuous streams of the first extrudable material into a single continuous layer upon exiting the internal die body 31 but within the feed block 18.

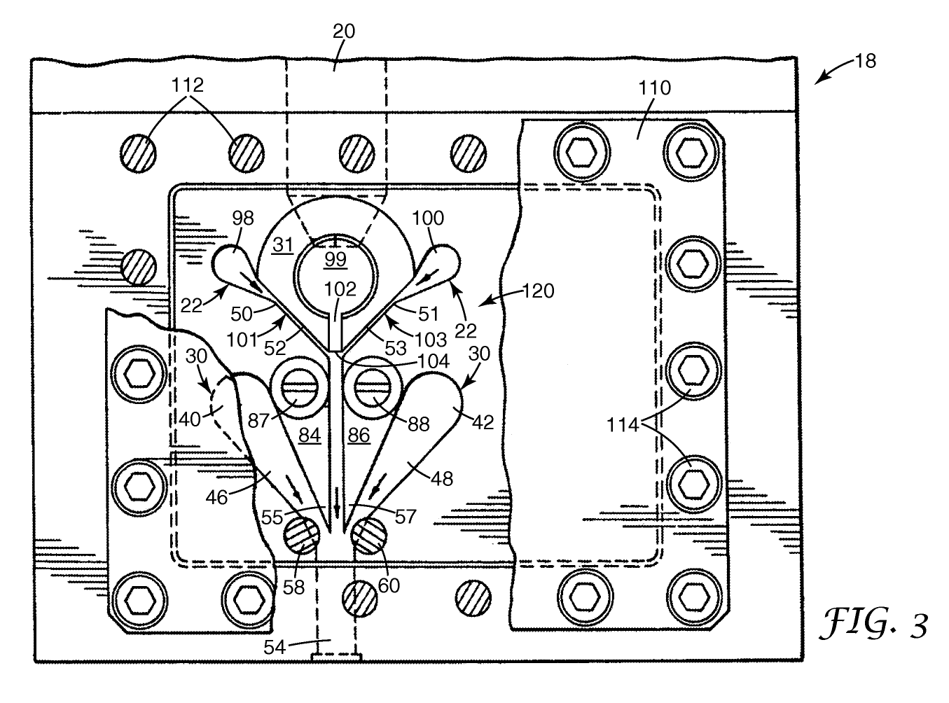

FIG. 3 illustrates an alternative embodiment in which an internal die body 31 is used in conjunction with at least one pair of layer-forming channels 40 and 42 positioned within the feed block 18 to produce a multi-layer composite film (see, for example, FIGS. 5F and 5G). The feed block 18 includes a feed block chamber 120 and a feed block cover 110 which may, in some embodiments, be removed to access the feed block chamber. A plurality of bolts 114 inserted into a plurality of bolt holes 112 may be used to secure the feed block cover 110 to the feed block 18.

Referring to FIG. 3, an internal die body 31 is shown positioned within the feed block chamber 120 of feed block 18. The feed block chamber 120 has internal surfaces defining a first flow channel 101 and a second flow channel 103, each of which is in fluid communication with a transverse land channel 98 and 100 in fluid communication with a first fluid delivery conduit 22 (hidden behind transverse land channels 98 and 100 in FIG. 3). The internal die body 31 is disposed between the first flow channel 101 and the second flow channel 103 within the feed block 18.

The internal die body 31 includes a transverse flow-providing passage 99 in fluid communication with a transverse internal die exit channel 102. The transverse internal die exit channel 102 includes a plurality of orifices (not shown in FIG. 3) formed on an external face 102 of the internal die body 31 in fluid communication with a second fluid delivery conduit 20. The feed block 18 has a first internal wall 50 which cooperates with a first face 52 of the die body 31 to form the first flow channel 101, and a second internal wall 51 which cooperates with a second face 53 of the die body 31 to form the second flow channel 103. A feed block exit channel 54 is formed in an external face of the feed block in fluid communication with the first flow channel 101, the second flow channel 103, and the transverse internal die exit channel 102.

Also positioned within feed block 18, in the embodiment of FIG. 3, is at least one pair of layer-forming channels 46 and 48 positioned on opposite sides of the feed block exit channel 54 downstream of and in fluid communication with the transverse internal die exit channel 102. In one exemplary embodiment, each layer-forming channel 46 and 48 is also in fluid communication between the feed block exit channel 54 and corresponding transverse land channels 40 and 42, which are in fluid communication with a third fluid delivery conduit 30 (hidden behind transverse land channels 40 and 42 in FIG. 3). This configuration results in a multi-layer film (see e.g. FIG. 5G) in which a single additional extrudable material 25 is applied to both major side surfaces of the composite web before exiting the feed block. Alternatively, each land channel 40 and 42 may be in fluid communication with separate fluid delivery conduits capable of delivering different additional extrudable materials to each respective channel. In this alternative exemplary embodiment (not illustrated in the Figures), a different additional extrudable material may be applied to each major side surface of the composite web before exiting the feed block.

Furthermore, in some embodiments, each layer-forming channel 46 and 48 may be positioned proximate a corresponding adjustable vane 84 and 86. Each adjustable vane 84 and 86 may be movably positioned to at least partially occlude the corresponding layer-forming channel 46 and 48, respectively. In some embodiments, at least one adjustable vane 84 or 86 may be positioned to fully occlude the corresponding layer-forming channel 46 and 48. Optional access port 58 and/or access port 60 may be installed in the feed block 18 to facilitate adjustment of the corresponding vane 84 and/or 86 from outside of the feed block 18.

Vanes 84 and 86 may, in some embodiments, be independently adjustable in at least one of two modes. Either one or both of vane 84 and/or vane 86 may be pivoted so the corresponding tip 55 or 57 can be moved closer to the exit of the corresponding layer-forming channel 46 or 48, thereby partially occluding the corresponding layer-forming channel 46 or 48, respectively, and causing a difference in gap for one or both of the layer-forming channels 46 or 48. This difference in gap can result in a different layer thickness for each additional layer made with an additional extrudable material (see e.g. additional extrudable material 25 in FIGS. 1), thereby forming one or more additional layers of extrudable material 25 (not shown in FIG. 3) of the same or different thickness on both major side surfaces of the single-layer composite web formed by the first and second extrudable materials 15 and 17 upon exiting internal die 31 (see e.g. FIG. 5G for exemplary additional layers 25 formed on both major side surfaces of the single-layer composite web 2 to form a three-layer multi-layer web 4). The difference in gap may also be used to maintain a constant layer thickness if each layer is made with additional extrudable material having a time-variable melt viscosity. Although the phases 15 are often uniformly spaced across the single-layer composite web 2 in the cross-web direction as shown in FIGS. 5A-5J, the width, and spacing of the phases also may be altered by adjustment of adjustable vane 84 (and/or 86).

Alternatively, in some embodiments, one or both vanes 84 and/or 86 may be positioned to completely occlude the corresponding layer-forming channel 46 and 48, respectively, thereby causing formation of a multi-layer web in which the co-extruded single-layer composite web is positioned as a layer adjacent to one major side surface of the multi-layer web (see e.g. FIG. 5F for an exemplary single-sided additional layer formed on one major side surface of the single-layer composite web). In other words, the co-extruded single composite web includes one or more additional layers formed on one major side surface of the single-layer composite web. In some embodiments, the vanes 84 and/or 86 can also be adjusted by replacement of tip 55 and/or 57 with one having orifices of varying shapes and/or spacing, thereby permitting formation of multi-layer webs having discontinuous or irregularly-shaped additional layers adjacent to or overlaying the co-extruded single-layer composite web.

As described above, in certain embodiments, adjustable vane 84 and/or 86 may be adjusted by rotation around an axis through a pivotable fixture 87 or 88, respectively. Thus if one additional extrudable material 25 is less viscous than the other, it may be possible to narrow the gap through which the less viscous matrix material flows in order to maintain uniformity of layer thickness of each of the two matrix layers. The gaps can be altered during processing in order to account for variations in processing conditions, such as changes in the temperature, pressure, flow rate, or viscosity over time. Thus, if feed block 18 has a warmer upper portion than lower portion resulting in lower viscosity of materials flowing through the upper gap, then the gaps can be adjusted to account for this change in viscosity. In addition, the gaps can be altered to achieve a different thickness in each matrix layer. This may be particularly useful when each matrix layer may be of a different material, e.g., a thermoplastic elastomer and a pressure-sensitive adhesive, or where different properties are desired from each layer of the multi-layer web.

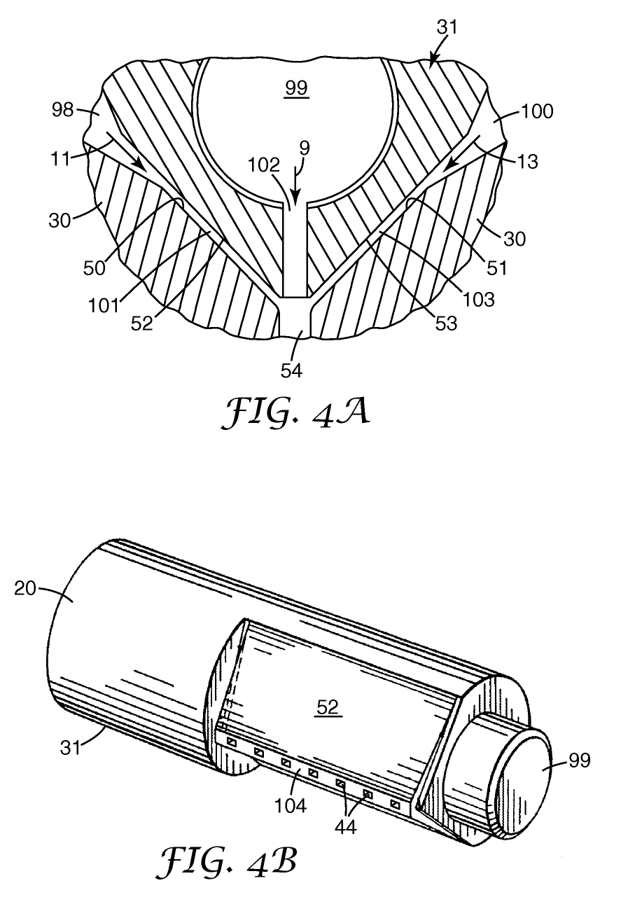

The manner in which the co-extruded single-layer composite web 2 (not shown) may be formed with the internal die body 31 within feed block 18 is shown with more particularity in FIGS. 4A and 4B, which are detailed views of portions of the feed block 18 of FIG. 3. Referring to FIG. 4A, an internal die body 31 is shown positioned within the feed block cavity 30 of feed block 18. The feed block 18 includes a first flow channel 101 and a second flow channel 103, each of which is in fluid communication with a corresponding transverse land channel 98 and 100, respectively. Each transverse land channel 98 and 100 is in fluid communication with the second fluid delivery conduit 22. The internal die body 31 is disposed between the first flow channel 101 and the second flow channel 103 within the feed block 18.

The die body 31 includes a transverse flow-providing passage 99 in fluid communication with a transverse internal die exit channel 102. The transverse internal die exit channel 102 exits the external face 104 of the internal die through a plurality of orifices 44 (see FIG. 4B) in fluid communication with the first fluid delivery conduit 20. The feed block 18 has a first internal wall 50 which cooperates with a first face 52 of the die body 31 to form the first flow channel 101, and a second internal wall 51 which cooperates with a second face 53 of the die body 31 to form the second flow channel 103. A feed block exit channel 54 is formed in an external face 56 of the feed block 18 in fluid communication with the first flow channel 101, the second flow channel 103, and the transverse internal die exit channel 102.

The overall structure of the presently disclosed single-layer composite web may be formed by any convenient matrix forming process such as by pressing materials together, co-extruding or the like, but co-extrusion is the presently preferred process for forming a single-layer composite web with a discontinuous core embedded within a continuous polymeric matrix material. Co-extrusion per se is known and may be described, for example, in Chisholm et al U.S. Pat. No. 3,557,265, Leferre et al. U.S. Pat. No. 3,479,425, and Schrenk et al. U.S. Pat. No. 3,485,912. Tubular co-extrusion (i.e. to form a filament or fiber) or double bubble extrusion (i.e. to form a blown film) is also possible for certain applications. The discontinuous core and matrix material are typically co-extruded through a specialized die that will bring the diverse materials into contact to shape the composite material to the desired form.

Various conventional dies are known for forming a multi-layer co-extruded web or film having a continuous core layer sandwiched between additional layers. In such dies, the core stream exiting from the die is sandwiched within additional streams exiting from flow channels formed within the die body. Virtually any such conventional multi-layer extrusion die may be advantageously used in conjunction with Applicant's feed block configurations to form multilayer composite articles having discontinuous phase inclusions, as described below.

In addition, a number of co-extrusion dies are known for producing multi-layer composite articles, such as films, in which a discontinuous core is embedded between two additional film layers. Such dies may also be used advantageously with the feed block of Applicant's disclosure to produce multi-layer composite articles having an embedded layer of discontinuous phase inclusions. For example, Schrenk et al. employs a single main orifice and polymer passageway die. In the main passageway, which would carry the matrix material, may be a nested second housing having a second passageway. The second passageway would have one or more outlets, each defining an elastomeric core, which discharges matrix material flowstreams into the main passageway matrix flow region. This composite flow then exits the orifice of the main passageway, thereby forming a multilayer film having an embedded discontinuous core.

One particular feed block useful in practicing a co-extrusion process according to the present disclosure is characterized by a removable die within a feed block, as described in U.S. Pat. No. 4,789,513. The die may be rigidly mounted between a first flow channel and a second flow channel, and extrudable material passed though the die to produce a continuous core of a first extrudable material surrounded on each side by a layer of a second extrudable material. Such known feed blocks are not capable of forming a discontinuous core layer, and the core layer must be sandwiched between two layers of the second extrudable material. This configuration precludes formation of a single-layer co-extruded article having an embedded discontinuous phase. This configuration also precludes formation of a multi-layer co-extruded film in which the single-layer composite web, having a discontinuous core layer of a first extrudable material surrounded by a matrix of a second extrudable material, is positioned as one of the outer layers of the multi-layer film.

However, by replacing the removable die within the feed block with a die configured with a plurality of cutouts or orifices as described below, the feed block may be used to form a single-layer or multi-layer film having a composite layer having a discontinuous core layer of a first extrudable material surrounded by a matrix of a second extrudable material. In addition, the composite layer may be positioned between additional layers of extrudable material, as an outer layer in a multi-layer film, or as a self-supporting single-layer film

Another advantageous co-extrusion process may be possible with a modified multi-layer, e.g. a three-layer, feed block or combining adapter such as made by Cloeren Co. (Orange, Tex.). Combining adapters are described in Cloeren U.S. Pat. No. 4,152,387 discussed above. The combining adapter may be used in conjunction with extruders, optionally in combination with multi-layer feed blocks, supplying the extrudable materials. Such an apparatus for producing multi-layer composite materials is shown schematically in FIG. 1A, using a three layer feed block as shown in FIG. 3, to form composite multi-layer articles including discontinuous phase inclusions within a continuous matrix material, as shown in FIG. 5C.

FIGS. 5A-5I show various embodiments of a co-extruded single-layer composite web 2 produced by use of co-extrusion apparatus 10 of FIG. 1. FIGS. 5A-5E illustrate cross-web cross-sectional views of exemplary single-layer composite webs 2 having a plurality of discontinuous included phases of a first extrudable material 15 embedded in a continuous matrix of a second extrudable material 17 to form the single-layer composite web 2.

FIGS. 5F and 5G illustrate cross-web cross-sectional views of exemplary multilayer composite webs 4 formed by applying one or more additional layers of an additional extrudable material 25 to one or both major side surfaces of the single-layer composite web 2. The additional layers may be applied within the feed block 18, or alternatively, within a die 19 external to the feed block 18, as illustrated in FIG. 1.

FIGS. 5H and 5I illustrate cross-web cross-sectional views of exemplary single-layer composite webs 2 having a plurality of discontinuous included phases of a first extrudable material 15 embedded in a continuous matrix of a second extrudable material 17 in an arrangement corresponding to certain exemplary two-dimensional array patterns. One skilled in the art will understand that other arrangements of two-dimensional array patterns are possible, as are other cross-sectional shapes for the plurality of discontinuous included phases.

FIG. 5J illustrates an exemplary single-layer composite web 2 which has been additionally processed to form a multi-layer web, for example, by compressing stretching the single-layer composite web in the cross-web direction to form a continuous core layer of a first extrudable material 15 embedded in a continuous matrix of a second extrudable material 17, wherein the continuous core layer exhibits a periodic cross-sectional profile. In such embodiments, it may be preferred that the first extruded material be a liquid, an elastomer, or a plasticized polymer. The additional processing may include, for example, passing the single-layer composite web through an external heated shaping die, crushing, or calendaring the single-layer composite web (e.g. by passing the single-layer composite web through the nip between two heated rollers), and the like. Other suitable processing methods are known to those skilled in the art.

In another embodiment, the disclosure provides a method of making a co-extruded composite having discontinuous phase inclusions. The method includes introducing a first extrudable material into a first flow channel and a second flow channel formed within a feed block; introducing a second extrudable material into a plurality of orifices formed in a die body disposed between the first flow channel and the second flow channel within the feed block; and combining the first extrudable material and the second extrudable material in a feed block exit channel to form a single-layer composite web. The first extrudable material forms a continuous matrix material surrounding a plurality of discontinuous included phases embedded in the continuous matrix material.

The included phases may be separate from each other by being discontinuous in a cross-web direction as shown in FIGS. 5A-5J, but the included phases may also be substantially continuous in the down-web direction. The single-layer composite web may be passed through an external multi-layer extrusion die to form a multi-layer composite article. The multi-layer composite article may be selected from, for example, a multi-layer film, a multi-layer fiber, or a multi-layer fiber.

Incorporation of the plurality of discontinuous phase inclusions in the matrix material within the feed block may provide several advantages. Discontinuous phase inclusions with dimensions X in the cross-web direction greater than the composite web thickness Y may be produced. For example, FIGS. 5E, 5G, and 5H each illustrate exemplary embodiments of a composite web 2 in which discontinuous phase inclusions 15 embedded in a continuous matrix material 17 have dimensions X in the cross-web direction greater than the composite web thickness Y. Multiple layers may also be extruded around the composite layer containing the discontinuous phase inclusions to form multi-layer composite webs 4 having an embedded composite layer 2 having discontinuous phase inclusions 15 within a matrix material 17, as illustrated by FIGS. 5F and 5G.

In some embodiments of Applicant's disclosure, the adjustable vanes within the feed block may be replaced with vanes that are fused in a fixed position. This has the effect of blocking subsequent layer flows while helping to form the discontinuous phase inclusions in the matrix material within the feed block. Multiple layers may be stacked upon this centralized layer or blocked off so that this discontinuous layer is offset from all other layers.

Fixing the position of the vanes in certain embodiments of Applicant's feed block configuration may allow fewer problems with leakage of the polymer melt stream as it passes through the shaping insert. In addition, since the core layer is formed discontinuously within the feed block, the composite web has additional time to undergo stress relaxation before entering the forming region with the die cavity. This additional relaxation time may act to reduce or eliminate expansion or contraction of the composite web upon exiting the die, thereby permitting more precise control of the width of the inclusions and thickness and uniformity of the composite web.

In some embodiments, this may permit formation of a composite web on or around which other extruded layers may be formed in the die to produce a multi-layer composite film without producing a non-uniform surface “ripple” pattern on the surface of the additional extruded layers due to swelling or contraction of the underlying discontinuous phase upon exiting the die. In certain embodiments, the thickness of the multi-layer composite film or web in a region overlaying a discontinuous phase varies by less than 5% from the thickness of the multi-layer composite film in a region not overlaying any discontinuous phase. In other embodiments, the thickness of the multi-layer composite film or web in a region overlaying a discontinuous phase varies by less than 1% from the thickness of the multi-layer composite web in a region not overlaying any discontinuous phase.

In additional embodiments, a physical property gradient (e.g. a refractive index, light transmission, density, compositional, color, or physical property gradient) between the discontinuous phase inclusions and the surrounding matrix may be created by controlling the design of the feed block die insert and the pressure and mass flowrate of the extrudable materials within the feed block. Such physical property gradients may be useful in preparing films for use in identification cards, document security, anti-counterfeiting applications, and the like. Another variation of a physical property variation is to use a lower molecular weight polymer as the discontinuous phase inclusions and a higher molecular weight polymer as the continuous matrix material. The resulting rheological properties of the polymers can be used to cause the discontinuous phase inclusions to spread within the die to make a continuous layer.

It will be understood by one skilled in the art that although the foregoing discussion refers to formation of a web or film including a composite layer having discontinuous phase inclusions, other co-extruded articles, for example ropes, fibers, melt-blown articles, and the like, may also be advantageously produced using the apparatus and methods described in this disclosure. The inventive composite web material has an unlimited range of potential widths (or diameters if formed into a filament or fiber), the width limited solely by the fabricating machinery width limitations.

The precise extruders employed in the inventive process are not critical as any device able to convey melt streams to a die of the invention may be satisfactory. However, it may be understood that the design of the extruder screw will influence the capacity of the extruder to provide good polymer melt quality, temperature uniformity, and throughput. A number of useful extruders are known and include single and twin screw extruders. These extruders are available from a variety of vendors including Davis-Standard Extruders, Inc. (Pawcatuck, Conn.), Black Clawson Co. (Fulton, N.Y.), Berstorff Corp (N.C.), Farrel Corp. (Connecticut), and Moriyama Mfg. Works, Ltd. (Osaka, Japan). Other apparatus capable of pumping organic melts may be employed instead of extruders to deliver the molten streams to the forming die of the invention. They include drum unloaders, bulk melters and gear pumps. These are available from a variety of vendors, including Giraco LTI (Monterey, Calif.), Nordson (Westlake, Calif.), Industrial Machine Manufacturing (Richmond, Va.), Zenith Pumps Div., and Parker Hannifin Corp. (N.C.).

Once the molten streams have exited the pump, they are typically transported to the die through transfer tubing and/or hoses. It may be preferable to minimize the residence time in the tubing to avoid problems of, for example, melt temperature variation. This can be accomplished by a variety of techniques, including minimizing the length of the tubing. Alternatively, melt temperature variation in the tubing can be minimized by providing appropriate temperature control of the tubing, or utilizing static mixers in the tubing. Patterned tools which contact the web can provide surface texture or structure to improve the ability to tear the web in the cross web or transverse direction without affecting the overall tensile strength or other physical properties of the product.

By using the internal die body 31 within the feed block 18, extrudable materials 15 and 17 may be co-extruded in a controlled manner. The materials may be brought together in the melt state, thereby allowing for improved adhesion to one another. In addition, even when the materials are not normally compatible, they may still be co-extruded in order to produce a web retaining the properties of each of the materials. The die and feed block used are typically heated to facilitate polymer flow and layer adhesion. The temperature of the die depends upon the polymers employed and the subsequent treatment steps, if any. Generally the temperature of the die may be not critical but temperatures are generally in the range of 350° F. to 550° F. (176.7° C. to 287.8° C.) with the polymers exemplified. Accordingly, the composite web, whether in the form of a single-layer or multi-layer web, is preferably cooled upon exiting the external die.

A number of additional steps can optionally be performed after extrusion. For example, the web may be uniaxially (i.e. lengthwise or width-wise) or biaxially (i.e. both length-wise and width-wise) oriented, either sequentially or simultaneously, can be cured (such as through heat, electromagnetic radiation, etc.), or can be dusted with various tack-reducing agents.

Another way of modifying the properties of the co-extruded webs of the invention may be to use specific materials having desired properties for the layers of the matrix and the embedded discontinuous phases. Suitable polymeric materials for forming the matrix layers and embedded phases of the inventive co-extruded web are any that can be thermally processed and include pressure sensitive adhesives, thermoplastic materials, elastomeric materials, polymer foams, high viscosity liquids, etc. Suitable materials useful in practicing the various embodiments of the present disclosure are known to those skilled in the art. Exemplary materials are described in U.S. Pat. No. 6,447,875 to Norquist et al.

Gases or supercritical fluids may also be incorporated as the discontinuous included phase to form a foam. Foams are those materials made by combining the above polymeric materials with blowing agents. Physical foaming agents, for example gases like carbon dioxide or nitrogen, ethane, butane, isobutane and the like; heated water or steam may be incorporated in the discontinuous included phase to form a foam, a void, a channel or a tube.

Chemical blowing agents may also be used to generate foams, voids, channels or tubes in melt processable materials. Suitable blowing agents are known in the art and include, for example, SAFOAM™ RIC-50, a citric acid sodium bicarbonate-based chemical blowing agent, or certain isocyanates that may be reacted in situ with water to release carbon dioxide gas. The resulting mixtures may then be subjected to various conditions known in the art to activate the blowing agent used to form a multiplicity of cells within the polymer. Additional cross-linking may occur to cause the resulting foams to be more stable.

Thermoexpandable microcapsules or beads of encapsulated blowing agents (e.g. hydrocarbons, such as butane or isobutene) covered with a thermoplastic resin shell material may also be used. Heating the microcapsules causes softening of the shell material and vaporization of the blowing agent leading to increased internal pressure and rapidly increase volume by 100 times or more. Suitable thermoexpandable microcapsules are the CLOCELL® materials (available from PolyChemAlloy, Granite Falls, N.C.).

High viscosity liquids are suitable as embedded discontinuous included phase materials. They are any liquids that do not diffuse through the matrix material and prematurely escape the article of the invention. These include, for example, various silicone oils, mineral oils and specialty materials having a sharp melting temperature around or below room temperature.

Viscosity reducing polymers and plasticizers can also be blended with the elastomers. These viscosity reducing polymers include thermoplastic synthetic resins such as polystyrene, low molecular weight polyethylene and polypropylene polymers and copolymers or tackifying resins such as Wingtack™ resin (from Goodyear Tire & Rubber Company, Akron, Ohio). Examples of tackifiers include aliphatic or aromatic liquid tackifiers, aliphatic hydrocarbon resins, polyterpene resin tackifiers, and hydrogenated tackifying resins.

Various additives may be incorporated into the phase(s) and/or the matrix to modify the properties of the finished web. For example, additives may be incorporated to improve the adhesion of the discontinuous phases and the matrix to one another. Additives such as dyes, pigments, antioxidants, antistatic agents, bonding aids, antiblocking agents, slip agents, heat stabilizers, photostabilizers, foaming agents, glass bubbles, starch and metal salts for degradability or microfibers can also be used in the elastomeric phase. Suitable antistatic aids include ethoxylated amines or quaternary amines such as those described, for example, in U.S. Pat. No. 4,386,125 (Shiraki), which also describes suitable antiblocking agents, slip agents and lubricants. Softening agents, tackifiers or lubricants are described, for example, in U.S. Pat. No. 4,813,947 (Korpman) and include coumarone-indene resins, terpene resins, hydrocarbon resins and the like. These agents can also function as viscosity reducing aids. Conventional heat stabilizers include organic phosphates, trihydroxy butyrophenone or zinc salts of alkyl dithiocarbonate.

The co-extruded web may also be laminated to a fibrous web. Preferably, the fibrous web may be a nonwoven web such as a consolidated or bonded carded web, a melt-blown web, a spunbond web, or the like. The fibrous web alternatively may be bonded or laminated to the co-extruded web by adhesives, thermal bonding, extrusion, ultrasonic welding or the like. Preferably, the co-extruded web can be directly extruded onto one or more fibrous webs. Short fibers or microfibers can also be used to reinforce the embedded phase(s) or matrix layers for certain applications. These fibers include polymeric fibers, mineral wool, (glass fibers, carbon fibers, silicate fibers and the like.

Glass bubbles or foaming agents may be used to lower the density of the matrix layer or embedded phases and can be used to reduce cost by decreasing the content of an expensive material or the overall weight of a specific article. Suitable glass bubbles are described in U.S. Pat. Nos. 4,767,726 and 3,365,315. Furthermore, certain filler particles can be used, including, carbon and pigments. Fillers can also be used to some extent to reduce costs. Exemplary fillers, which can also function as anti-blocking agents, include titanium dioxide and calcium carbonate.

Additional embodiments and advantages are further illustrated by the following examples, but the particular materials and amounts thereof recited in these examples, as well as other conditions and details, should not be construed to unduly limit this disclosure.

It is apparent to those skilled in the art from the above description that various modifications can be made without departing from the scope and principles of this disclosure, and it should be understood that this disclosure may be not to be unduly limited to the illustrative embodiments set forth hereinabove. All publications and patents are herein incorporated by reference to the same extent as if each individual publication or patent was specifically and individually indicated to be incorporated by reference. Various embodiments of the disclosure have been described. These and other embodiments are within the scope of the following claims.

1. A co-extrusion apparatus comprising:
(a) a feed block comprising a first flow channel and a second flow channel, each of which comprises a transverse land channel in fluid communication with a first fluid delivery conduit;
(b) an internal die body disposed between the first flow channel and the second flow channel within the feed block, the internal die body comprising a transverse flow-providing passage and, in fluid communication therewith, a transverse exit channel comprising a plurality of orifices formed on an external face of the internal die body, the orifices in fluid communication with a second fluid delivery conduit; wherein the feed block has a first internal wall which cooperates with a first face of the die body to form the transverse land channel of the first flow channel, and a second internal wall which cooperates with a second face of the die body to form a transverse land channlel of the second flow channel- and
(c) a feed block exit channel formed in an external face of the feed block, wherein the feed block exit channel is in fluid communication with the first flow channel, the second flow channel, and the transverse exit channel.

2. The co-extrusion apparatus of claim 1, further comprising an external die in fluid communication with the feed block exit channel.

3. The co-extrusion apparatus of claim 2, wherein the external die is a multi-layer die.

4. The co-extrusion apparatus of claim 2, wherein the external die is selected from a slot die, a tubular die, an annular die, a strand die, or a double bubble die.

5. The co-extrusion apparatus of claim 1, wherein the plurality of orifices is selected from circular orifices, elliptical orifices, square orifices, rectangular orifices, triangular orifices, and polygonal orifices having more than four sides.

6. The co-extrusion apparatus of claim 1, wherein the plurality of orifices is arranged in a two-dimensional array pattern across a surface of the transverse die exit channel on an external face of the internal die body,

7. The co-extrusion apparatus of claim 1, wherein each orifice is at least 1 mm from the nearest adjacent orifice.

8. The co-extrusion apparatus of claim 1, wherein the internal die body is removable from the feed block.

9. The co-extrusion apparatus of claim 1, further comprising at least one pair of layer-forming channels positioned within the feed block on opposite sides of the feed block exit channel downstream of the transverse exit channel, wherein each layer-forming channel is in fluid communication with the feed block exit channel and a third fluid delivery conduit, and further wherein each layer-forming channel is positioned proximate an adjustable vane, each adjustable vane being movably positioned to at least partially occlude the corresponding layer-forming channel.

10. The co-extrusion apparatus of claim 9, wherein at least one adjustable vane is positioned to fully occlude the corresponding layer-forming channel.

11. A method of making a co-extruded composite article having discontinuous phase inclusions comprising:
(a) introducing a first extrudable material into a first flow channel and a second flow channel formed within a feed block;
(b) introducing a second extrudable material into a plurality of orifices formed across a surface of a transverse exit channel in an external face of an internal die body disposed between the first flow channel and the second flow channel within the feed block; and
(c) combining the first extrudable material and the second extrudable material in a feed block exit channel to form a single-layer composite web within the feed block,
wherein the first extrudable material forms a continuous matrix material surrounding a plurality of discontinuous included phases embedded in the continuous matrix material,
wherein the included phases are separate from each other by being discontinuous in a cross-web direction, and wherein the phases are substantially continuous in the down-web direction.

12. The method of claim 11, wherein the single-layer composite web is further processed through an external die to form a multi-layer composite article.

13. The method of claim 11, wherein the single-layer composite web is further processed within the feed block to form a multi-layer composite article.

14. The method of claim 13, wherein the multi-layer composite article has, as an external layer, the single-layer composite web.

15. The method of claim 13, wherein the multi-layer composite article is selected from a multi-layer film, a multi-layer fiber, a multi-layer filament, or a multi-layer tube.

16. The method of claim 11, wherein a shape of each of the plurality of orifices is selected from circular orifices, elliptical orifices, square orifices, rectangular orifices, triangular orifices, and polygonal orifices having more than four sides, and wherein the non-continuous included phases have a cross-sectional shape in the down-web direction substantially identical to the shape of a corresponding orifice.

17. The method of claim 11 wherein the plurality of orifices is arranged in a two-dimensional array pattern across the surface of the transverse exit channel in the external face of the internal die body, and wherein the included phases are arranged substantially in the two dimensional array pattern within the single-layer composite web in a cross-web direction.

18. The method of claim 11, further comprising cooling the single-layer composite web.

19. The method of claim 11, further comprising orienting the single-layer composite web.

20. The method of claim 11, further comprising additional processing of the single-layer composite web, thereby forming a multi-layer composite web.

21. The method of claim 11, wherein a physical property of the single layer composite web is caused to vary between the discontinuous included phases and the surrounding matrix material.

22. A co-extruded single-layer composite web comprising:
a continuous layer of an extruded matrix material; and
a plurality of included phases embedded in the continuous layer, the phases being separate from each other by being discontinuous in the cross-web direction,
wherein the phases are substantially continuous in the down-web direction and are surrounded by the matrix material to form a single-layer composite web, and wherein a thickness of the single-layer composite web in a region overlaying a discontinuous phase varies by less than 5% from a thickness of the single-layer composite web in a region not overlaying arny discontinuous phase.

23. The co-extruded composite web of claim 22, wherein the thickness of the single-layer composite web in a region overlaying a discontinuous phase varies by less than 1% from the thickness of the single-layer composite web in a region not overlaying any discontinuous phase.

24. The co-extruded composite web of claim 22, wherein each included phase exhibits a cross-web width, and wherein the width of each included phase is greater than a thickness of the single-layer composite web.

25. The co-extruded composite web of claim 22, further comprising one or more additional layer formed on one or more major side surface of the single-layer composite web, thereby forming a multi-layer composite web.

27. The co-extruded composite web of claim 22, wherein the single-layer composite web is in the form of a sheet, a tube, or a fiber.

28. The co-extruded composite web of claim 22, wherein a physical property of the single
layer composite web varies between the discontinuous included phases and the surrounding matrix material.

29. A co-extruded multi-layer composite web comprising:
a continuous layer of an extruded matrix material;
a plurality of included phases embedded in the continuous layer, the phases being separate from each other by being discontinuous in the cross-web direction, wherein the phases are substantially continuous in the down-web direction and are surrounded by the matrix material to form a single-layer composite web, and;
one or more additional layer formed on one or more major side surface of the single-layer composite, web, thereby forming a multi-layer composite web.
